(19) United States
(12) Patent Application Publication
(10) Pub. No.: US 2025/0036051 A1
(43) Pub. Date: Jan. 30, 2025

(54) IMAGE FORMING SYSTEM

(71) Applicant: FUJIFILM Business Innovation Corp., Tokyo (JP)

(72) Inventors: Toshiyuki MIYATA, Kanagawa (JP); Shigeyuki Sakaki, Kanagawa (JP); Kiyoshi Koyanagi, Kanagawa (JP); Mizuki Sugino, Kanagawa (JP); Jouta Kobayashi, Kanagawa (JP)

(73) Assignee: FUJIFILM Business Innovation Corp., Tokyo (JP)

(21) Appl. No.: 18/443,413

(22) Filed: Feb. 16, 2024

(30) Foreign Application Priority Data
Jul. 27, 2023 (JP) 2023-122849

(51) Int. Cl. G03G 15/20; G03G 15/00

(52) U.S. Cl. CPC G03G 15/2046; G03G 15/2064; G03G 15/5016; G03G 15/5029; G03G 2215/00763; G03G 2215/00772; G03G 2215/00776

(57) ABSTRACT

An image forming system includes a transport unit that transports a recording medium by using a roller; a transfer unit that applies a transfer voltage by using a transfer body and that transfers a toner image to the recording medium that is transported by the transport unit; a fixing unit that fixes the toner image by using a heat roller to the recording medium to which the toner image is transferred; and a processor configured to: implement temperature control on the heat roller, based on a result of detection of an electric current value detector that detects an electric current value of an electric actuator that rotates the roller and a result of detection of a resistance value detector that detects volume resistivity of the recording medium when the toner image is transferred to the recording medium after the electric current value detector detects the electric current value.

### CROSS-REFERENCE TO RELATED APPLICATIONS

This application is based on and claims priority under 35 USC 119 from Japanese Patent Application No. 2023-122849 filed Jul. 27, 2023.

### BACKGROUND

### (i) Technical Field

The present disclosure relates to an image forming system.

### (ii) Related Art

Japanese Unexamined Patent Application Publication No. 2017-58481 discloses a fixing device including a detecting portion that detects a load applied to a driving portion configured to drive a fixing unit configured to fix an image formed on a medium, an identifying portion that identifies a type of the medium from a result of detection performed by the detecting portion, and a setting part that sets a threshold with reference to which the identifying portion identifies the type of the medium. The threshold is set for each of different temperatures detected by a temperature detecting portion that detects a temperature of the fixing unit or for each predetermined number of media on which images are fixed.

### SUMMARY

Aspects of non-limiting embodiments of the present disclosure relate to a reduction in a failure in a toner image that is fixed to a recording medium unlike the case where temperature control on a heat roller is implemented based on only the thickness of the recording medium or the heat capacity of the recording medium.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system including a transport unit that transports a recording medium by using a roller; a transfer unit that applies a transfer voltage by using a transfer body and that transfers a toner image to the recording medium that is transported by the transport unit; a fixing unit that fixes the toner image by using a heat roller to the recording medium to which the toner image is transferred; and a processor configured to: implement temperature control on the heat roller, based on a result of detection of an electric current value detector that detects an electric current value of an electric actuator that rotates the roller and a result of detection of a resistance value detector that detects volume resistivity of the recording medium when the toner image is transferred to the recording medium after the electric current value detector detects the electric current value.

### BRIEF DESCRIPTION OF THE DRAWINGS

Exemplary embodiments of the present disclosure will be described in detail based on the following figures, wherein:

FIG. 1 schematically illustrates the structure of an image forming apparatus that includes an image forming system according to an exemplary embodiment of the present disclosure;

FIG. 2 illustrates the structure of a toner image forming unit of the image forming apparatus according to the exemplary embodiment of the present disclosure;

FIG. 3 is a front view of a transfer unit according to the exemplary embodiment of the present disclosure in a color mode;

FIG. 4 is a control block diagram of the hardware configuration of the image forming apparatus;

FIG. 5 is a functional block diagram of the hardware configuration;

FIG. 6 illustrates a display unit;

FIG. 7 illustrates an example of an electric current that is detected by a torque detector;

FIG. 8 illustrates a heat capacity presumption map;

FIG. 9 illustrates a temperature control map;

FIG. 10 is a flowchart illustrating processing that is performed by a CPU;

FIG. 11 illustrates a first modification and corresponds to FIG. 1;

FIG. 12 is a functional block diagram of a hardware configuration according to the first modification;

FIG. 13 is flowchart illustrating processing that is performed by the CPU according to the first modification;

FIG. 14 illustrates a second modification and corresponds to FIG. 1; and

FIG. 15 is a flowchart illustrating processing that is performed by the CPU according to the second modification.

### DETAILED DESCRIPTION

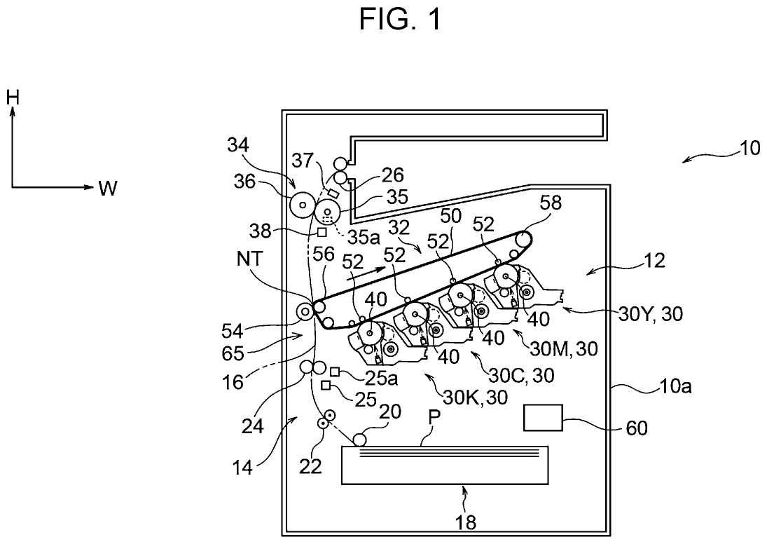

An example of an image forming system according to an exemplary embodiment of the present disclosure will be described with reference to FIG. 1 to FIG. 10. In the drawings, an arrow H represents a vertical direction, that is, an up-down direction of apparatus, and an arrow W represents a horizontal direction, that is, a width direction of apparatus.

### Entire Configuration of Image Forming Apparatus 10

As illustrated in FIG. 1, the image forming apparatus 10 includes an image forming unit 12 that forms toner images by using an electrophotographic system and a transport unit 14 that transports print paper (a recording medium) P that serves as a recording medium along a transport path 16. The image forming apparatus 10 includes a container member 18 that contains the print paper P and a controller 60 that controls the entire apparatus.

As for the image forming apparatus 10, the transport unit 14 transports the print paper P that is contained in the container member 18 along the transport path 16. The toner images that are formed by the image forming unit 12 are formed on the print paper P that is transported, and the print paper P on which the toner images are formed is discharged to a location outside a housing 10a by using discharge rollers 26 described later.

### Image Forming Unit 12

As illustrated in FIG. 1, the image forming unit 12 includes multiple toner image forming units 30 that form toner images in respective colors and a transfer unit 32 that transfers the toner images that are formed by the toner image forming units 30 to the print paper P. The image forming unit 12 includes a fixing device (a fixing unit) 34 that fixes, to the print paper P, the toner images that are transferred to the print paper P by using the transfer unit 32.

### Toner Image Forming Units 30

The multiple toner image forming units 30 are provided so as to form the toner images in the respective colors. According to the present exemplary embodiment, toner image forming units 30Y, 30M, 30C, and 30K for four colors of yellow (Y), magenta (M), cyan (C), and black (K) in total are provided. In the following description, Y, M, C, and K that are added into symbols are omitted in the case where it is not necessary to distinguish among yellow (Y), magenta (M), cyan (C), and black (K).

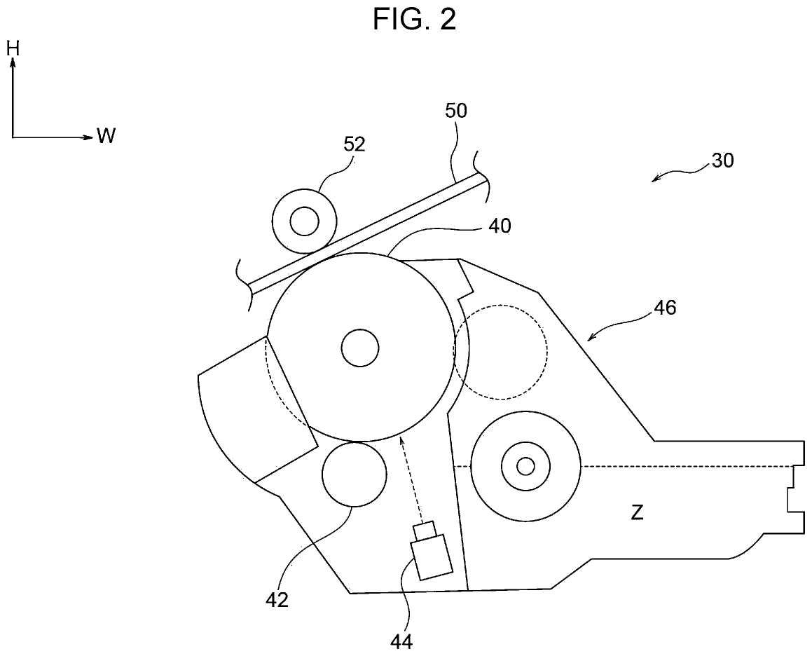

The toner image forming units 30 for the respective colors basically have the same structure except for toner that is used and include image carriers 40 that rotate and that have a cylindrical shape and chargers 42 that charge the image carriers 40 as illustrated in FIG. 2. The toner image forming units 30 further include exposure devices 44 that radiate exposure light to the image carriers 40 that are charged and form electrostatic latent images and developing devices 46 that develop the electrostatic latent images by using developer Z that contains the toner into the toner images. Consequently, the toner image forming units 30 for the respective colors form images in the respective colors by using the toner in the respective colors.

As illustrated in FIG. 1, the image carriers 40 for the respective colors are in contact with a transfer belt 50 that turns. The toner image forming units 30 of yellow (Y), magenta (M), cyan (C), and black (K) are arranged in this order from an upstream position in a direction (see an arrow in the figure) in which the transfer belt 50 turns.

### Transfer Unit 32

The transfer unit 32 has a function of transferring the toner images that are formed by the toner image forming units 30 to the print paper P. The transfer unit 32 will be described in detail later.

### Fixing Device 34

As illustrated in FIG. 1, the fixing device 34 is disposed downstream of a transfer nip NT in a direction in which the print paper P is transported. The fixing device 34 heats and presses the toner images that are transferred to the print paper P and fixes the toner images to the print paper P. More specifically, the fixing device 34 includes a heat roller 35 that contains a heater 35a and a pressure roller 36 that faces the heat roller 35 and that is rotated. The print paper P passes through a nip region between the heat roller 35 and the pressure roller 36, and the toner images on the print paper P are fixed to the print paper P due to heat and pressure. A temperature sensor that is designated by a symbol of 37 detects the surface temperature of the heat roller 35. The fixing device 34 includes an electric motor 38 that rotates the heat roller 35 at a predetermined speed.

### Transport Unit 14

As illustrated in FIG. 1, the transport unit 14 includes a feed roller 20 that feeds the print paper P that is contained in the container member 18 to the transport path 16 and prevention rollers 22 that prevent multiple pieces of the print paper P fed by the feed roller 20 from being fed. The transport unit 14 further includes resist rollers (rollers) 24 that adjust a timing with which the print paper P is fed to the transfer nip NT and the discharge rollers 26 that discharge the print paper P to which the toner images are fixed by the fixing device 34 to a location outside the housing 10a.

The resist rollers 24 rotate by using rotational force that is produced by an electric motor (an electric actuator) 25. The electric motor 25 is controlled by the controller 60. A torque detector (an electric current value detector) 25a is connected to the electric motor 25.

The torque detector 25a detects the torque of the electric motor 25 as an electric current value that flows through the electric motor 25.

The structure of the torque detector 25a according to the present exemplary embodiment is not particularly limited, provided that the torque of the electric motor 25 is detectable. For example, the torque detector 25a may detect the torque of the electric motor 25 as the electric current value that flows through the electric motor 25, may convert the detected electric current value into a voltage value, and may output the voltage value. The torque detector 25a may measure a voltage across shunt resistors and may detect an electric current. For example, as for the torque detector 25a, resistors may be provided on a path along which an electric current flows into the electric motor 25, may measure a voltage across the resistors, and may detect the electric current. For example, as for the torque detector 25a, an electric current sensor that includes a hole element may be provided on a path along which an electric current flows into the electric motor 25 and may detect the electric current. For example, the torque detector 25a may be a torque detector that detects the torque of the electric motor 25.

The transfer unit 32 will now be described.

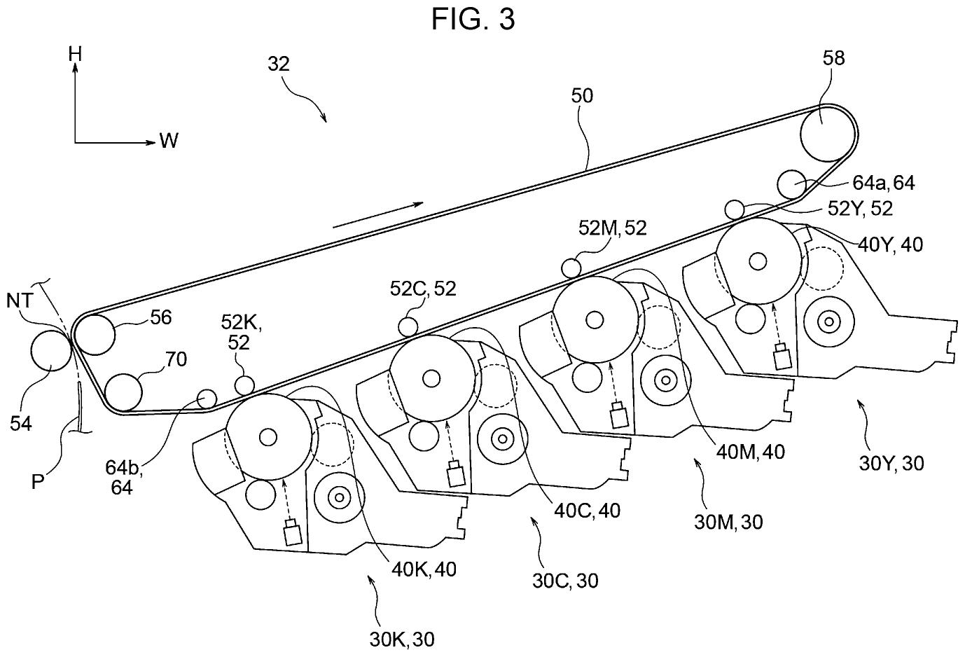

As illustrated in FIG. 3, the transfer unit 32 includes the transfer belt 50 and first transfer rollers 52 that are disposed opposite the respective image carriers 40 for the respective colors with the transfer belt 50 interposed therebetween and transfers the toner images in the respective colors that are formed by the image carriers 40 to the transfer belt 50. The transfer unit 32 also includes a contact-separation unit (not illustrated) that moves at least one of the first transfer rollers 52 among the multiple first transfer rollers 52 and brings the transfer belt 50 and the image carriers 40 into contact with each other or separates the transfer belt 50 and the image carriers 40 from each other.

The transfer unit 32 further includes a winding roller 56 around which the transfer belt 50 is wound, a drive roller 58, around which the transfer belt 50 is wound, which transmits rotational force to the transfer belt 50, and positioning rollers 64 that determine the positions of portions of the transfer belt 50 at which the toner images are transferred. The transfer unit 32 also includes an application roller 70 that applies tension to the transfer belt 50.

The transfer unit 32 further includes a second transfer roller 54 that is disposed opposite the winding roller 56 with the transfer belt 50 interposed therebetween and that transfers the toner images that are transferred to the transfer belt 50 to the print paper P. The transfer nip NT at which the toner images are transferred to the print paper P is formed between the second transfer roller 54 and the transfer belt 50.

### Transfer Belt 50, Winding Roller 56, and Drive Roller 58

As illustrated in FIG. 3, the transfer belt 50 has not ends and is disposed in a posture such that the periphery (the left-hand periphery in the figure) in the width direction of apparatus is below another periphery. The transfer belt 50 is an example of a member that has no ends.

The axial direction of the winding roller 56 coincides with a depth direction of apparatus. A peripheral portion of the transfer belt 50 in the width direction of apparatus is wound around the winding roller 56. The axial direction of the drive roller 58 coincides with the depth direction of apparatus. Another peripheral portion of the transfer belt 50 in the width direction of apparatus is wound around the drive roller 58.

With this structure, the drive roller 58 to which driving force is transmitted from a drive source not illustrated rotates, and consequently, the transfer belt 50 turns in the direction (a clockwise direction) of an arrow in the figure.

### First Transfer Rollers 52 and Second Transfer Roller 54

As illustrated in FIG. 3, the first transfer rollers 52 for the respective colors are disposed downstream of the drive roller 58 and upstream of the winding roller 56 in the direction (referred to below as a “belt turning direction”) in which the transfer belt 50 turns. The first transfer rollers 52 for the respective colors are in contact with an inner circumferential surface of the transfer belt 50 opposite the image carriers 40 for the respective colors with the transfer belt 50 interposed therebetween. The second transfer roller 54 is disposed opposite the winding roller 56 with the transfer belt 50 interposed therebetween. The first transfer rollers 52 are examples of a first transfer member. The second transfer roller 54 is an example of a second transfer member.

With this structure, the first transfer rollers 52 for the respective colors transfer the toner images that are formed on the image carriers 40 for the respective colors to the transfer belt 50 with the transfer belt 50 interposed between the image carriers 40 for the respective colors and the first transfer rollers 52. The second transfer roller 54 transfers the toner images that are transferred to the transfer belt 50 by using the first transfer rollers 52 to the print paper P that is transported at the transfer nip NT. The transfer voltage is applied to the second transfer roller 54 under constant-current control that is implemented by a constant-current controller 603 described later. A detection device that is capable of detecting that the print paper P hits the second transfer roller 54 is provided near the second transfer roller 54 although this is not illustrated. The detection device is connected to the controller 60.

### Application Roller 70 and Positioning Rollers 64

As illustrated in FIG. 3, the application roller 70 is disposed downstream of the first transfer roller 52K and upstream of the second transfer roller 54 in the belt turning direction. The application roller 70 is in contact with the inner circumferential surface of the transfer belt 50 and presses the transfer belt 50. Consequently, tension is applied to the transfer belt 50.

As illustrated in FIG. 3, the positioning rollers 64 that are paired are provided so as to interpose all of the first transfer rollers 52 therebetween in the belt turning direction. Specifically, a positioning roller 64a that is disposed upstream of all of the first transfer rollers 52 and a positioning roller 64b that is disposed downstream of all of the first transfer rollers 52 are provided in the belt turning direction.

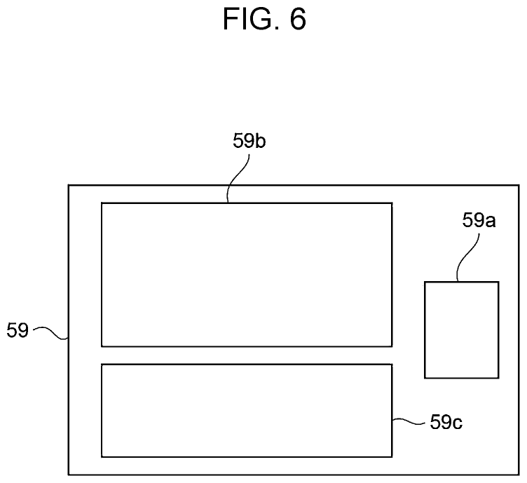

As illustrated in FIG. 6, the image forming apparatus 10 includes a display unit 59 that includes a touch screen. The display unit 59 includes an input unit (an information input unit) 59a and a first display unit 59b. For example, a user of the image forming apparatus 10 is able to input information about the kind of the print paper P for a print process by using the input unit 59a. Examples of the kind of the print paper P include plain paper and coated paper. The information that is inputted by using the input unit 59a is displayed on the first display unit 59b. For example, in the case where the user inputs information that represents plain paper by using the input unit 59a, characters “plain paper” are displayed on the first display unit 59b. A second display unit (a notification unit or a display unit) 59c displays notification under control of a display unit controller 606 described later.

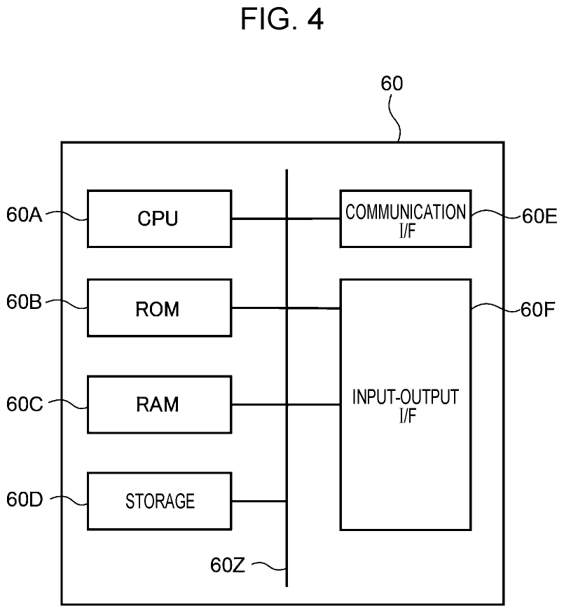

As illustrated in FIG. 4, the hardware configuration of the controller 60 includes a central processing unit (CPU) or a processor 60A, a read only memory (ROM) 60B, a random access memory (RAM) 60C, a storage 60D, a communication I/F (interface) 60E, and an input-output I/F 60F. The CPU 60A, the ROM 60B, the RAM 60C, the storage 60D, the communication I/F 60E, and the input-output I/F 60F are connected to each other so as to be capable of communicating with each other via a bus 60Z.

The CPU 60A is the central processing unit that runs various programs and that controls components. That is, the CPU 60A reads a program in the ROM 60B or the storage 60D and runs the program by using the RAM 60C as a work area. The CPU 60A controls components and performs various kinds of arithmetic processing in accordance with the programs that are recorded in the ROM 60B or the storage 60D.

The ROM 60B stores various programs and various kinds of data. The RAM 60C that serves as the work area temporarily stores a program or data. The storage 60D includes a storage device such as a hard disk drive (HDD) or a solid state drive (SSD) and stores various programs and various kinds of data. The communication I/F 60E is an interface for communication with another device.

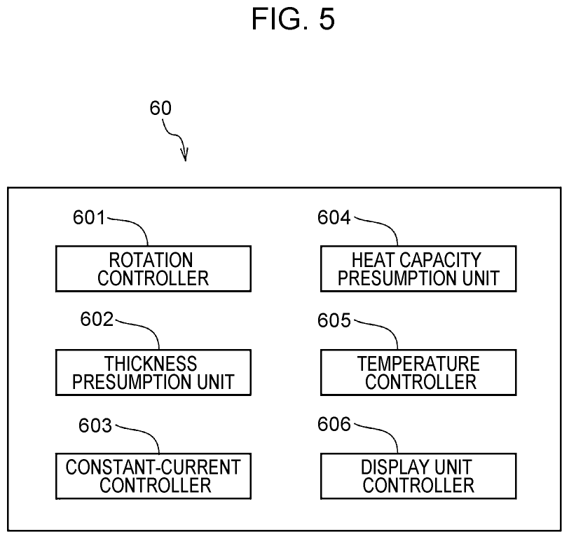

FIG. 5 is a block diagram of an example of the functional configuration of the controller 60. The functional configuration of the controller 60 includes a rotation controller 601, a thickness presumption unit 602, the constant-current controller 603, a heat capacity presumption unit (a resistance value detector) 604, a temperature controller 605, and the display unit controller 606. The CPU 60A reads the programs that are stored in the ROM 60B, and consequently, the rotation controller 601, the thickness presumption unit 602, the constant-current controller 603, the heat capacity presumption unit 604, the temperature controller 605, and the display unit controller 606 function.

The rotation controller 601 implements rotation control on the electric motor 25 and the electric motor 38.

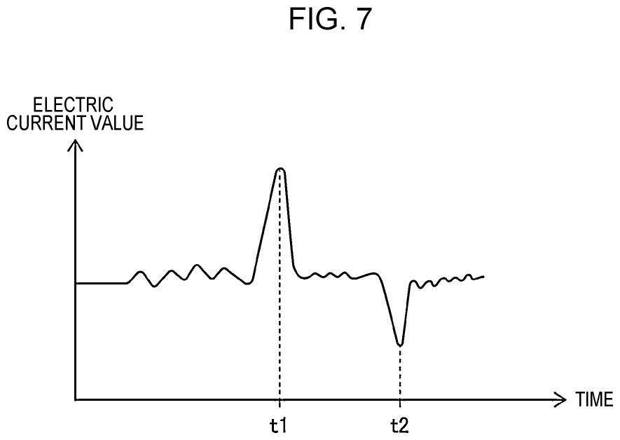

The thickness presumption unit 602 detects the thickness of the print paper P, based on the electric current value that is detected by the torque detector 25a. As illustrated in FIG. 7, the electric current value that is detected by the torque detector 25a sharply increases and peaks upward when the print paper P hits the resist rollers 24 and subsequently sharply reduces and peaks downward when the print paper P exits from between the resist rollers 24. In an example illustrated in FIG. 7, the print paper P hits the resist rollers 24 at a time t1, and the print paper P exits from between the resist rollers 24 at a time t2. As for the electric current that is detected by the torque detector 25a, peak values when the print paper P hits the resist rollers 24 and exits and a value when the print paper P passes through the resist rollers 24 change depending on the thickness of the print paper P. As for a detection function according to the present exemplary embodiment, the CPU 60A detects the thickness of the print paper P by using a variation in the electric current that is detected by the torque detector 25a depending on the thickness of the print paper P.

The constant-current controller 603 implements the constant-current control under which the transfer voltage is applied to the second transfer roller 54 as described above.

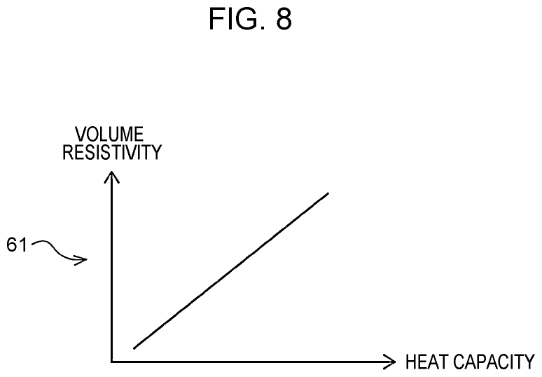

The heat capacity presumption unit 604 acquires the volume resistivity of the print paper P by using the electric current value and the voltage value of power that is supplied to the second transfer roller 54 under the constant-current control. The heat capacity presumption unit 604 presumes the heat capacity of the print paper P by using a heat capacity presumption map 61 (see FIG. 8) in which a relationship between the volume resistivity of the print paper P and the heat capacity of the print paper P is defined and the acquired volume resistivity of the print paper P. As clear from FIG. 8, the heat capacity of the print paper P and the volume resistivity are substantially proportional to each other. The heat capacity presumption map 61 is an example, and the relationship between the volume resistivity and the heat capacity that is defined in the heat capacity presumption map 61 may be corrected in consideration for temperature and humidity in the housing 10a.

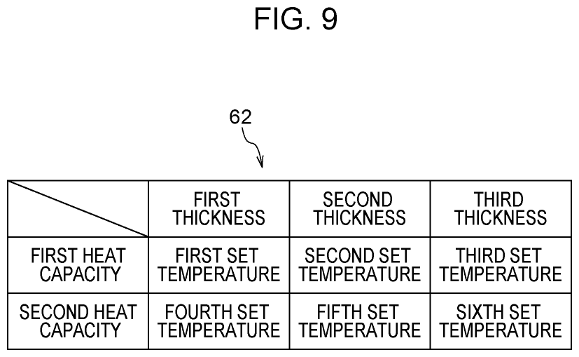

The temperature controller 605 uses the thickness of the print paper P that is presumed by the thickness presumption unit 602 and the heat capacity of the print paper P that is presumed by the heat capacity presumption unit 604 for a temperature control map 62 illustrated in FIG. 9 that is recorded in the ROM 60B and consequently controls the heater 35a. The temperature control map 62 is a two-dimensional map that is defined by using the thickness of the print paper P and the heat capacity of the print paper P. The thickness of the print paper P in the temperature control map 62 is defined by using three thicknesses. The heat capacity in the temperature control map 62 is defined by using two capacities. The thickness of the print paper gradually increases in order of a first thickness, a second thickness, and a third thickness. The second heat capacity is larger than the first heat capacity. For example, in the case where the presumed thickness of the print paper P is the “second thickness”, and the presumed heat capacity of the print paper P is the “first heat capacity”, the temperature controller 605 controls the heater 35a such that the target temperature (the temperature that is detected by the temperature sensor 37) of the heat roller 35 becomes a second set temperature.

The display unit controller 606 controls the display unit 59. For example, the display unit controller 606 causes the first display unit 59b to display information that is inputted by the input unit 59a.

In the case where the information about the kind of the print paper P that is inputted by the input unit 59a differs from the presumed kind of the print paper P, the display unit controller 606 causes the second display unit 59c to display notification. Paper information about the heat capacities and thicknesses of various kinds of print paper is recorded in the ROM 60B. For this reason, in the case where information about the thickness of the print paper P that is inputted by the input unit 59a is included in the paper information, the second display unit 59c displays notification if the information about the thickness that is included in the paper information differs from the thickness that is presumed by the thickness presumption unit 602. In the case where information about the heat capacity of the print paper P that is inputted by the input unit 59a is included in the paper information, the second display unit 59c displays notification if the information about the heat capacity that is included in the paper information differs from the heat capacity that is presumed by the heat capacity presumption unit 604. For example, in the case where information about the print paper P that is inputted by the input unit 59a is paper that has a predetermined thickness, and the print paper P that is presumed by the thickness presumption unit 602 is paper that has a thickness greater than the predetermined thickness, the second display unit 59c displays characters the “kind of paper for printing differs from the kind of paper that is inputted”. In the case where the heat capacity of the print paper P that is inputted by the input unit 59a has a predetermined value, and the heat capacity of the print paper P that is presumed by the heat capacity presumption unit 604 is greater than the predetermined value, the second display unit 59c displays characters the “kind of paper for printing differs from the kind of paper that is inputted”.

Among the components described above, the transport unit 14, the resist rollers 24, the electric motor 25, the torque detector 25a, the transfer unit 32, the fixing device 34, the second transfer roller 54, the display unit 59, the controller 60, the heat capacity presumption map 61, and the temperature control map 62 are included in an image forming system 65.

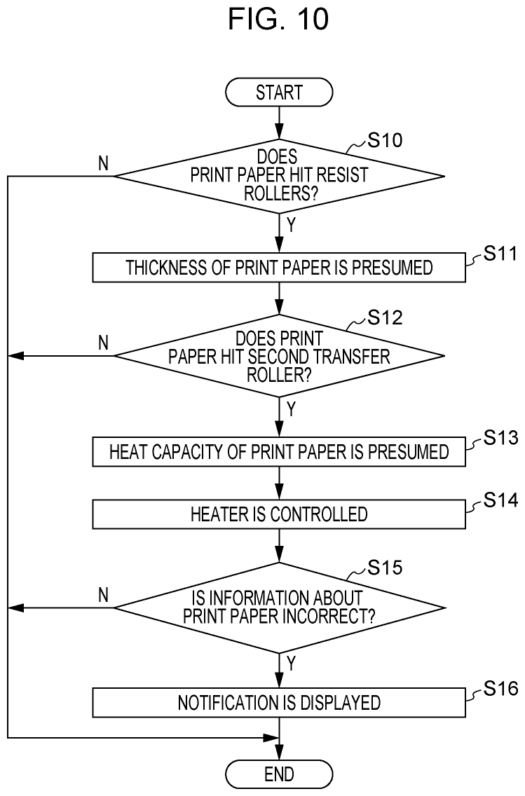

The actions of the image forming apparatus 10 thus configured will now be described with reference to a flowchart in FIG. 10. The CPU 60A repeatedly performs processing in the flowchart in FIG. 10 for every predetermined time.

As a step S10 (in the following description, the characters “step” are omitted), the CPU 60A determines whether the print paper P hits the resist rollers 24, based on information that is received from the torque detector 25a.

If determination at S10 is Yes, the CPU 60A proceeds to S11 and presumes the thickness of the print paper P, based on the information that is received from the torque detector 25a.

In the case where a process at S1l ends, the CPU 60A proceeds to S12 and determines whether the print paper P hits the second transfer roller 54, based on information that is received by the detection device.

If determination at S12 is Yes, the CPU 60A proceeds to S13 and presumes the heat capacity of the print paper P, based on the volume resistivity of the print paper P and the heat capacity presumption map 61.

In the case where a process at S13 ends, the CPU 60A proceeds to S14, uses information about the thickness of the print paper P that is acquired at S11 and information about the heat capacity of the print paper P that is acquired at S13 for the temperature control map 62, and consequently controls the heater 35a such that the target temperature of the heat roller 35 becomes a set temperature that is defined in the temperature control map 62.

In the case where a process at S14 ends, the CPU 60A proceeds to S15 and determines whether information about the print paper P that is inputted by using the input unit 59a is incorrect.

If determination at S15 is Yes, the CPU 60A proceeds to S16, and the second display unit 59c displays notification.

If the determination at S10, S12, and S15 is No, or when a process at S16 ends, the CPU 60A ends the processing in the flowchart in FIG. 10 once.

The image forming system 65 according to the present exemplary embodiment implements the temperature control on the heat roller 35 (the heater 35a), based on both of the thickness of the print paper P and the heat capacity of the print paper P as described above. For example, an image forming system that is thought in a comparative example implements the temperature control on the heat roller 35 (the heater 35a), based on only the thickness of the print paper P. As for the image forming system in the comparative example, temperature control on a heat roller (a heater) in the case where toner images are formed on print paper A (not illustrated) is the same as temperature control on the heat roller (the heater) in the case where toner images are formed on print paper B (not illustrated) that has the same thickness as the print paper A and a heat capacity that differs from that of the print paper A. For this reason, as for the image forming system in the comparative example, a failure in the toner images that are fixed to at least the print paper A or the print paper B is likely to occur.

In the case where the thickness of the print paper P is presumed by using a roller that is provided downstream of the second transfer roller 54 and upstream of the heat roller 35 and the pressure roller 36 and an electric actuator that applies driving force to the roller, there is a possibility that the roller distorts the toner images on the print paper P. However, the image forming system 65 according to the present exemplary embodiment presumes the thickness of the print paper P by using the resist rollers 24 and the electric motor 25 that are located upstream of the second transfer roller 54, and accordingly, the resist rollers 24 do not distort the toner images on the print paper P.

In the case where the thickness of the print paper P is presumed by using the heat roller 35 and the electric motor 38, the temperature control on the heat roller 35 (the heater 35a) cannot be implemented based on both of the thickness of the print paper P and the heat capacity of the print paper P when the print paper P that is firstly fed from the container member 18 to the heat roller 35 and the pressure roller 36 after a switch of the image forming apparatus 10 is turned on hits the heat roller 35 and the pressure roller 36. However, the image forming system 65 according to the present exemplary embodiment presumes the thickness of the print paper P by using the resist rollers 24 and the electric motor 25 that are located upstream of the second transfer roller 54, and accordingly, the temperature control on the heat roller 35 (the heater 35a) is implemented based on both of the thickness of the print paper P and the heat capacity of the print paper P also when the print paper P that is firstly fed from the container member 18 to the heat roller 35 and the pressure roller 36 hits the heat roller 35 and the pressure roller 36.

The image forming system 65 presumes the thickness of the print paper P by using the resist rollers 24 and the electric motor 25 that correspond to existing members in an image forming apparatus. For this reason, the number of the components of the image forming system 65 is smaller than that of a structure that includes a roller exclusively for measuring the thickness of the print paper P.

As for the image forming system 65, the second display unit 59c displays notification in the case where the information about the kind of the print paper P that is inputted into the input unit 59a differs from the presumed kind of the print paper P. In this way, the image forming system 65 may enable the user who inputs the information about the kind of the print paper P into the input unit 59a to recognize that the information about the kind of the print paper P that is inputted is incorrect.

The image forming apparatus 10 according to the present exemplary embodiment is described above with reference to the drawings. The image forming apparatus 10 according to the present exemplary embodiment, however, is not limited by the drawings, and a modification in design may be appropriately made without departing from the spirit of the exemplary embodiment of the disclosure.

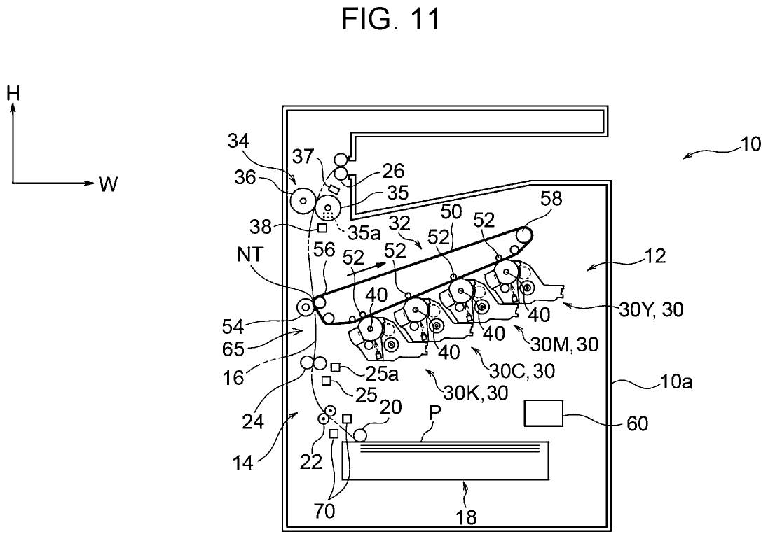

For example, the exemplary embodiment of the disclosure may be carried out according to a first modification illustrated in FIG. 11 to FIG. 13. As illustrated in FIG. 11, a basis weight detector 70 is provided in the housing 10a according to the first modification. The basis weight detector 70 is located downstream of the feed roller 20 and upstream of the prevention rollers 22. The basis weight detector 70 measures the basis weight of the print paper P that is transported by the transport unit 14. For example, the basis weight detector 70 may be a device that detects the basis weight by radiating light toward the print paper P and measuring light that passes through the print paper P. The basis weight detector 70 may be a device that detects the basis weight by radiating ultrasonic waves toward the print paper P and measuring ultrasonic waves that pass through the print paper P. The basis weight detector 70 is connected to the controller 60.

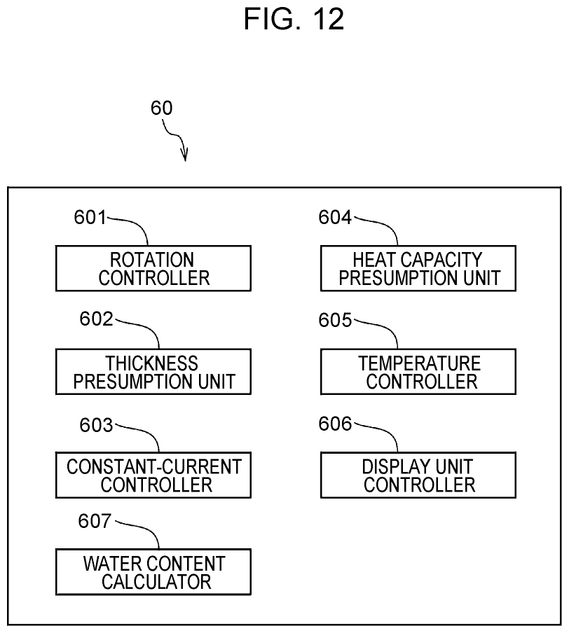

FIG. 12 illustrates a block diagram that represents an example of the functional configuration of the controller 60 according to the first modification. The functional configuration of the controller 60 includes the rotation controller 601, the thickness presumption unit 602, the constant-current controller 603, the heat capacity presumption unit 604, the temperature controller 605, the display unit controller 606, and a water content calculator 607. The water content calculator 607 calculates the water content of the print paper P, based on the humidity value and the volume resistivity of the print paper P. For example, the water content calculator 607 calculates the water content of the print paper P by using a map (not illustrated) in which a relationship between the humidity value and the volume resistivity is defined.

In the case where the calculated water content is equal to or more than a predetermined first threshold, and the value of the basis weight that is acquired by the basis weight detector 70 is within a predetermined range, the temperature controller 605 performs a reduction process of reducing the temperature of the heat roller 35 to a temperature lower than a set temperature unlike the case where the water content is less than the first threshold or the basis weight is out of the predetermined range. That is, the temperature controller 605 controls the heater 35a such that the temperature of the heat roller 35 is lower than the set temperature that is acquired based on the temperature control map 62 by a predetermined value. In the case where the print paper P is plain paper, the value of the basis weight of the print paper P is within the predetermined range.

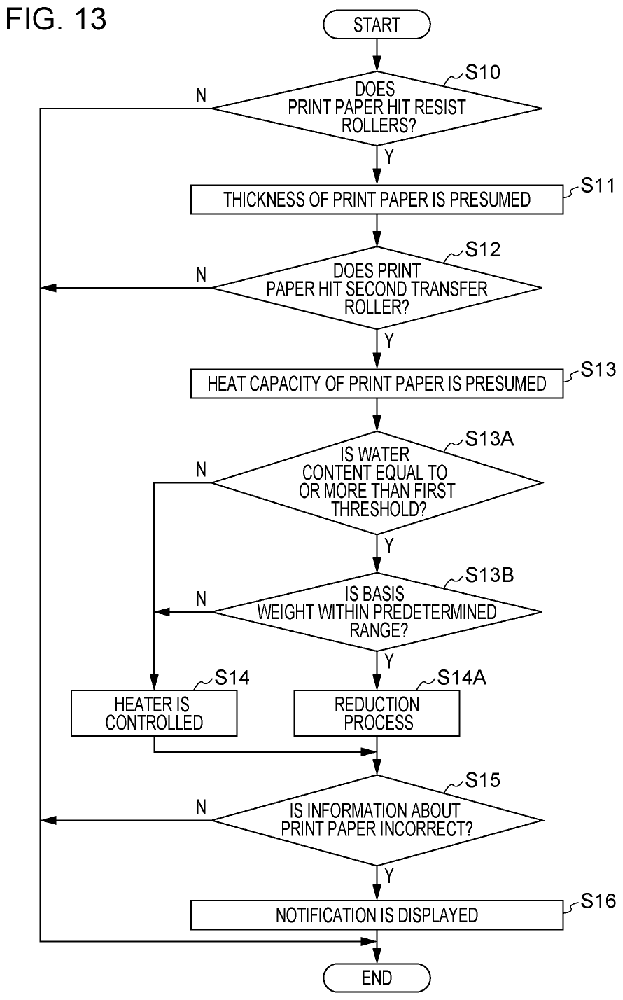

The CPU 60A according to the first modification repeatedly performs processing in a flowchart in FIG. 13 for every predetermined time.

Processes at S10 to S13 are the same as those according to the exemplary embodiment.

In the case where the process at S13 ends, the CPU 60A proceeds to S13A and determines whether the water content of the print paper P is equal to or more than the first threshold.

If determination at S13A is Yes, the CPU 60A proceeds to S13B and determines whether the value of the basis weight of the print paper P is within the predetermined range.

If determination at S13B is Yes, the CPU 60A proceeds to S14A and implements the temperature control on the heat roller 35 while performing the reduction process.

If the determination at S13B is No, the CPU 60A proceeds to S14.

In the case where a process at S14 or S14A ends, the CPU 60A proceeds to S15.

The image forming system 65 according to the first modification performs the reduction process in the case where the water content of the print paper P is equal to or more than the first threshold, and the value of the basis weight that is acquired by the basis weight detector 70 is within the predetermined range as described above. For this reason, the print paper P is unlikely to curl unlike the case where the temperature of the heat roller 35 is constant regardless of the water content and the basis weight of the print paper P. That is, for example, in the case where the reduction process is not performed when the water content of the print paper P is equal to or more than the first threshold, water is excessively lost from a surface of the print paper P with which the heat roller 35 comes into contact, a difference between the amounts of water on the front and back of the print paper P increases, and consequently, the print paper P is likely to curl. According to the first modification, the water content of the print paper P is equal to or more than the first threshold, and the value of the basis weight that is acquired by the basis weight detector 70 is within the predetermined range, the reduction process is performed. Accordingly, the difference between the amounts of water on the front and back of the print paper P is unlikely to increase, and the print paper P is unlikely to curl.

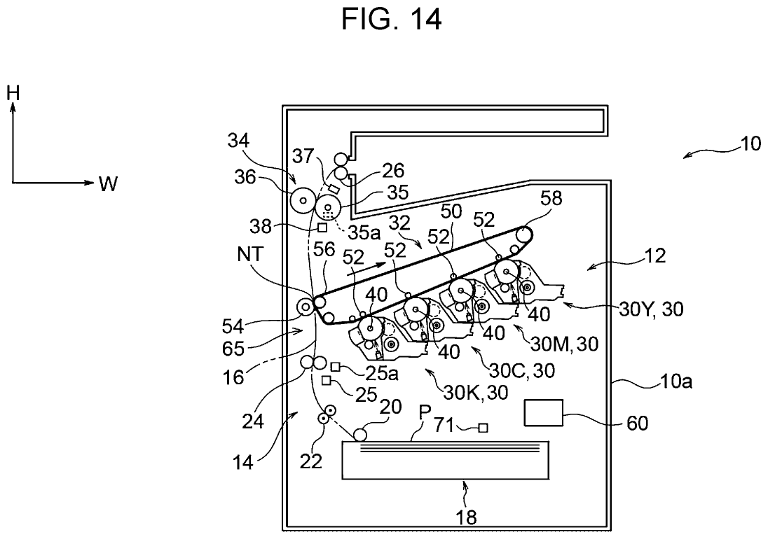

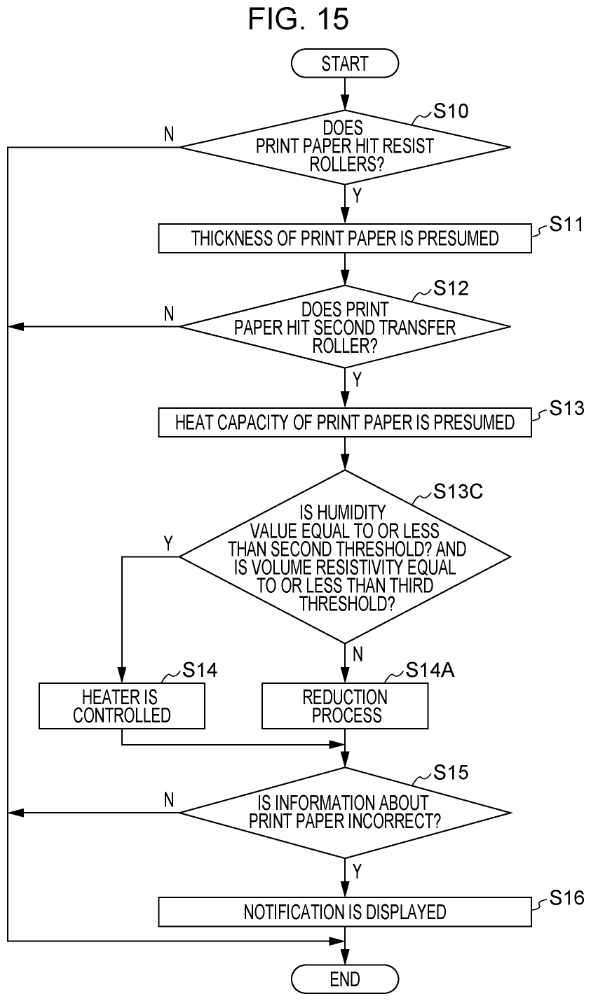

The exemplary embodiment of the disclosure may be carried out according to a second modification illustrated in FIG. 14 and FIG. 15. As illustrated in FIG. 14, a temperature-and-humidity sensor 71 is provided in the housing 10a according to the second modification. The temperature-and-humidity sensor 71 detects the temperature and the humidity in the housing 10a. In the following description, the humidity that is detected by the temperature-and-humidity sensor 71 is referred to as a humidity value. The temperature-and-humidity sensor 71 is connected to the controller 60.

The temperature controller 605 according to the second modification does not perform the reduction process in the case where the humidity value is equal to or less than a second threshold, and the volume resistivity of the print paper P is equal to or less than a third threshold. The temperature controller 605 performs the reduction process in the case where the humidity value is more than the second threshold, or the volume resistivity is more than the third threshold.

The CPU 60A according to the second modification repeatedly performs processing in a flowchart in FIG. 15 for every predetermined time.

Processes at S10 to S13 are the same as those according to the exemplary embodiment.

In the case where the process at S13 ends, the CPU 60A proceeds to S13C and determines whether the humidity value is equal to or less than second threshold, and the volume resistivity of the print paper P is equal to or less than the third threshold.

If determination at S13C is Yes, the CPU 60A proceeds to S14. If the determination at S13C is No, the CPU 60A proceeds to S14A.

In the case where the process at S14 or S14A ends, the CPU 60A proceeds to S15.

The image forming system 65 according to the second modification does not perform the reduction process in the case where the humidity value is equal to or less than the second threshold, and the volume resistivity of the print paper P is equal to or less than the third threshold as described above. That is, in the case where the humidity value is equal to or less than the second threshold, it is presumed that the water content of the print paper P is low. For this reason, it is not necessary to perform the reduction process in this case.

The image forming system 65 according to the second modification performs the reduction process in the case where the humidity value is more than the second threshold, or in the case where the volume resistivity is more than the third threshold. For this reason, the print paper P is unlikely to curl unlike the case where the temperature of the heat roller 35 is constant regardless of the humidity value and the volume resistivity.

The image forming apparatus 10 is not limited by intermediate transfer but may be a color or monochrome image forming apparatus by using direct transfer. Also in this case, the heat capacity of the print paper P may be presumed by using a roller for transfer.

The image forming system 65 may implement the temperature control on the heat roller 35 (the heater 35a), based on the result of detection of the torque detector 25a and the result of detection of the heat capacity presumption unit (the resistance value detector) 604 after the temperature control on the heat roller 35 (the heater 35a) is started based on only the result of detection of the torque detector (the electric current value detector) 25a. That is, the image forming system 65 may implement control on the heater 35a, based on the temperature control map 62 after the heater 35a is controlled such that the temperature of the heat roller 35 becomes the target temperature, based on only the result of detection of the torque detector (the electric current value detector) 25a.

The recording medium may differ from the print paper P. For example, the recording medium may be a transparent film.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) An image forming system includes a transport unit that transports a recording medium by using a roller; a transfer unit that applies a transfer voltage by using a transfer body and that transfers a toner image to the recording medium that is transported by the transport unit; a fixing unit that fixes the toner image by using a heat roller to the recording medium to which the toner image is transferred; and a processor configured to: implement temperature control on the heat roller, based on a result of detection of an electric current value detector that detects an electric current value of an electric actuator that rotates the roller and a result of detection of a resistance value detector that detects volume resistivity of the recording medium when the toner image is transferred to the recording medium after the electric current value detector detects the electric current value.

(((2)))

As for the image forming system described in (((1))), the roller of the transport unit is a resist roller.

(((3)))

The image forming system described in ((((1))) or ((2))) further includes an information input unit into which a user is able to input information about a kind of the recording medium; and a notification unit that is capable of notifying the user in which the processor is configured to: presume the kind of the recording medium, based on the result of detection of the electric current value detector and the result of detection of the resistance value detector, and the notification unit performs a notification operation when it is determined that the presumed kind of the recording medium differs from the kind of the recording medium that is represented by the information that is inputted into the information input unit.

(((4))) As for the image forming system described in (((3))), the notification unit is a display unit that is capable of displaying information about the presumed kind of the recording medium.

(((5)))

As for the image forming system described in any one of (((1))) to (((4))), the processor is configured to implement the temperature control on the heat roller, based on the result of detection of the electric current value detector and the result of detection of the resistance value detector after the temperature control on the heat roller is started based on only the result of detection of the electric current value detector.

(((6)))

The image forming system described in any one of (((1))) to (((5))) further includes a housing that contains the transport unit, the transfer unit, and the fixing unit; a temperature-and-humidity sensor that is provided in the housing; and a basis weight detector that detects a basis weight of the recording medium in which the processor is configured to: presume a water content of the recording medium, based on a humidity value that is detected by the temperature-and-humidity sensor and the volume resistivity of the recording medium; acquire the basis weight of the recording medium from the basis weight detector; and perform a reduction process of reducing temperature of the heat roller in a case where the presumed water content is equal to or more than a first threshold, and the acquired basis weight is within a predetermined range, unlike a case where the water content is less than the first threshold or the basis weight is not within the predetermined range.

(((7)))

The image forming system described in any one of (((1))) to (((6))) further includes a housing that contains the transport unit, the transfer unit, and the fixing unit; and a temperature-and-humidity sensor that is provided in the housing in which the processor is configured not to perform a reduction process of reducing temperature of the heat roller in a case where a humidity value that is detected by the temperature-and-humidity sensor is equal to or less than a second threshold, and the volume resistivity of the recording medium is equal to or less than a third threshold, unlike a case where the humidity value is more than the second threshold or the volume resistivity of the recording medium is more than the third threshold.

(((8)))

As for the image forming system described in (((7))), the processor is configured to perform the reduction process in the case where the humidity value is more than the second threshold, or the volume resistivity is more than the third threshold.

What is claimed is:

1. An image forming system comprising:
a transport unit that transports a recording medium by using a roller;
a transfer unit that applies a transfer voltage by using a transfer body and that transfers a toner image to the recording medium that is transported by the transport unit;
a fixing unit that fixes the toner image by using a heat roller to the recording medium to which the toner image is transferred; and
a processor configured to:
implement temperature control on the heat roller, based on a result of detection of an electric current value detector that detects an electric current value of an electric actuator that rotates the roller and a result of detection of a resistance value detector that detects volume resistivity of the recording medium when the toner image is transferred to the recording medium after the electric current value detector detects the electric current value.

2. The image forming system according to claim 1,
wherein the roller of the transport unit is a resist roller.

3. The image forming system according to claim 1, further comprising:
an information input unit into which a user is able to input information about a kind of the recording medium; and
a notification unit that is capable of notifying the user,
wherein the processor is configured to presume the kind of the recording medium, based on the result of detection of the electric current value detector and the result of detection of the resistance value detector, and
wherein the notification unit performs a notification operation when it is determined that the presumed kind of the recording medium differs from the kind of the recording medium that is represented by the information that is inputted into the information input unit.

4. The image forming system according to claim 2, further comprising:
an information input unit into which a user is able to input information about a kind of the recording medium; and
a notification unit that is capable of notifying the user,
wherein the processor is configured to presume the kind of the recording medium, based on the result of detection of the electric current value detector and the result of detection of the resistance value detector, and
wherein the notification unit performs a notification operation when it is determined that the presumed kind of the recording medium differs from the kind of the recording medium that is represented by the information that is inputted into the information input unit.

5. The image forming system according to claim 3,
wherein the notification unit is a display unit that is capable of displaying information about the presumed kind of the recording medium.

6. The image forming system according to claim 4,
wherein the notification unit is a display unit that is capable of displaying information about the presumed kind of the recording medium.

7. The image forming system according to claim 1,
wherein the processor is configured to implement the temperature control on the heat roller, based on the result of detection of the electric current value detector and the result of detection of the resistance value detector after the temperature control on the heat roller is started based on only the result of detection of the electric current value detector.

8. The image forming system according to claim 2,
wherein the processor is configured to implement the temperature control on the heat roller, based on the result of detection of the electric current value detector and the result of detection of the resistance value detector after the temperature control on the heat roller is started based on only the result of detection of the electric current value detector.

9. The image forming system according to claim 1, further comprising:
a housing that contains the transport unit, the transfer unit, and the fixing unit;
a temperature-and-humidity sensor that is provided in the housing; and
a basis weight detector that detects a basis weight of the recording medium,
wherein the processor is configured to:
presume a water content of the recording medium, based on a humidity value that is detected by the temperature-and-humidity sensor and the volume resistivity of the recording medium;
acquire the basis weight of the recording medium from the basis weight detector; and
perform a reduction process of reducing temperature of the heat roller in a case where the presumed water content is equal to or more than a first threshold, and the acquired basis weight is within a predetermined range, unlike a case where the water content is less than the first threshold or the basis weight is not within the predetermined range.

10. The image forming system according to claim 2, further comprising:
a housing that contains the transport unit, the transfer unit, and the fixing unit;
a temperature-and-humidity sensor that is provided in the housing; and
a basis weight detector that detects a basis weight of the recording medium,
wherein the processor is configured to:
presume a water content of the recording medium, based on a humidity value that is detected by the temperature-and-humidity sensor and the volume resistivity of the recording medium;
acquire the basis weight of the recording medium from the basis weight detector; and
perform a reduction process of reducing temperature of the heat roller in a case where the presumed water content is equal to or more than a first threshold, and the acquired basis weight is within a predetermined range, unlike a case where the water content is less than the first threshold or the basis weight is not within the predetermined range.

11. The image forming system according to claim 1, further comprising:
a housing that contains the transport unit, the transfer unit, and the fixing unit; and
a temperature-and-humidity sensor that is provided in the housing,
wherein the processor is configured not to perform a reduction process of reducing temperature of the heat roller in a case where a humidity value that is detected by the temperature-and-humidity sensor is equal to or less than a second threshold, and the volume resistivity of the recording medium is equal to or less than a third threshold, unlike a case where the humidity value is more than the second threshold, or the volume resistivity of the recording medium is more than the third threshold.

12. The image forming system according to claim 11,
wherein the processor is configured to perform the reduction process in the case where the humidity value is more than the second threshold, or the volume resistivity is more than the third threshold.

13. An image forming system comprising:
means for transporting a recording medium by using a roller;
means for applying a transfer voltage by using a transfer body and for transferring a toner image to the recording medium that is transported by the means for transporting;
means for fixing the toner image by using a heat roller to the recording medium to which the toner image is transferred; and
means for implementing temperature control on the heat roller, based on a result of detection of an electric current value detector that detects an electric current value of an electric actuator that rotates the roller and a result of detection of a resistance value detector that detects volume resistivity of the recording medium when the toner image is transferred to the recording medium after the electric current value detector detects the electric current value.
